(19) United States
(12) Patent Application Publication
(10) Pub. No.: US 2022/0068079 A1
(43) Pub. Date: Mar. 3, 2022

(54) PARKING MANAGEMENT SYSTEM

(71) Applicant: Passport Labs, Inc., Charlotte, NC (US)

(72) Inventors: Bradley Powers, Charlotte, NC (US); Albert Lucas Segars, III, Charlotte, NC (US); Mark Wilson, China Grove, NC (US)

(21) Appl. No.: 17/463,770

(22) Filed: Sep. 1, 2021

Related U.S. Application Data
(60) Provisional application No. 63/073,114, filed on Sep. 1, 2020.

(51) Int. Cl. G07F 17/24; G06F 16/22; G06F 16/955

(52) U.S. Cl. CPC G07F 17/24; G06F 16/955; G06F 16/22

(57) ABSTRACT

A parking management system includes a rate increment generator operable to: compute one or more rate increments based on at least one of: a vehicle identification, a time of day, a local parking policy, a local events, a parking congestion, and a temporary rule; store the at least one rate increment; and transmit the at least one rate increment in response to an inquiry from a user interface.

### BACKGROUND OF THE INVENTION

This invention relates to software related to parking management, and more specifically to parking management software.

It is known in the prior art to utilize a computer-implemented user interface to interact with a parking management system.

Prior art limits the types of available user interfaces by coupling some of the complexity of the environment with the user interface.

There are three important factors in modern parking systems that make it difficult to support additional user interfaces, for example, popular consumer navigation applications or in-vehicle software systems.

The first factor involves the application and calculation of parking policy to each parking location. Parking policy can vary dramatically from location to location, include both static and dynamic inputs, and may vary based on the vehicle attempting to park. For context, some example parking policies include:
Parking location #1 offers parking for $1/hr., but may only be purchased in 12-minute intervals. Paid parking exists from 8 am-5 pm on all days except for Sundays, and users are allowed to start sessions at 7 am but are not charged until 8 am.
Parking location #2 offers parking for $1/hr. for the first hour and $2/hr. for each hour afterwards. Users can park for up to two hours per session, and up to three hours per day.
Parking location #3 prices parking dynamically based on statistical predictions of parking availability; the price may change regularly throughout the day within a city-defined range. Certain fuel-efficient vehicle classes receive discounts on the standard parking fee.
Parking location #4 offers “early bird” pricing from 6-8 am and then a standard price starting at 8 am. Early bird parkers must leave by 5 pm, but standard price parkers may leave their vehicles overnight. Early bird parkers can pay an additional fee to stay overnight.

The second factor involves the processing and settlement of funds across many parking operators based on the parking location where the parking session takes place. These integrations typically must be configured by the provider of the user interface when enabling each new parking operator.

The third factor involves supporting necessary downstream integrations, including integrations with parking enforcement software, financial reporting software, and data storage systems which vary from parking operator to parking operator; these systems may be managed by the parking operator or third-party vendors. These integrations are typically performed by the provider of each user interface when enabling each new parking operator.

### SUMMARY

The above-noted factors are addressed by aspects of the present invention, which describes a parking management system enabling a network-connected application, software application, or device to generate parking transactions across a plurality of parking operators.

### BRIEF DESCRIPTION OF THE DRAWINGS

The invention may be best understood by reference to the following description taken in conjunction with the accompanying drawing figures, in which:

FIG. 1 is a diagram showing an overview of the major components of a parking management system in the context of a single parking operator, including relevant interactions between each component; and

FIG. 2 provides a tabular representation of rate increments.

### DETAILED DESCRIPTION

Aspects of the present invention introduce features for software-based parking systems to reduce the complexity of supporting many different policy and environment configurations; this allows for a much larger group of user interfaces to provide parking payment functionality than is currently possible in existing solutions.

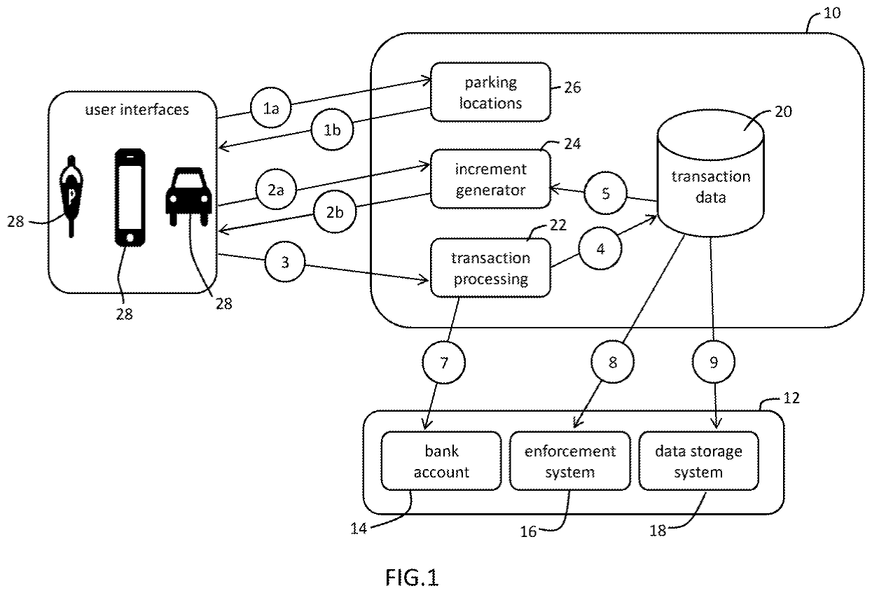

Now, referring to the drawings wherein identical reference numerals denote the same elements throughout the various views, FIG. 1 illustrates an exemplary parking management system 10, according to one aspect of the present invention, for use by one or more parking operators.

As used herein, the term “parking operator” or “facility operator” refers to an entity which controls physical access to a facility such as a parking space or parking lot. Typically, the parking operator or facility operator has legal ownership of or lease rights to the parking space or parking lot and is entitled to permit or deny access to the lot, collect fees for usage of the lot, and/or have unauthorized vehicles removed from the space or lot. A typical example of a parking operator could include a private parking company and/or a city in the case of a municipal parking lot.

A typical parking operator (shown schematically at reference 12 in FIG. 1) is associated with a financial account such as a bank account 14, an enforcement system 16, and a data storage system 18, each of these elements have data network connectivity.

In the figures, operative connections between elements or entities are depicted in a single-line format. It will be understood that these are representative of suitable connections for the exchange of data (e.g. wired connections, wireless connections, and/or data networks).

The parking management system 10 includes a transaction database 20, a transaction processing module 22, a rate increment generator 24, and a parking location registry 26. It will be understood that the parking management system 10 may be hosted on one or more computer servers or individual user devices, which are connected to a wide area network. The parking management system 10 is depicted schematically in block diagram format as being hosted on a single computer server. It will be understood that multiple servers or groups of computer servers could be used.

The parking management system 10 is interoperable with one or more user interfaces 28. As used herein, the term “user interface” includes any device or combination of devices having one or more microprocessors operable to execute programmed instructions and supporting components such as an electrical power source (e.g. battery or AC power source), input/output devices (e.g. keyboard, touchscreen display, microphone, and/or speakers), and one or more transceivers operable to communicate data over various network protocols.

In one example, the user interface 28 can be implemented as firmware and/or software in a device such as a parking meter.

In another example, the user interface 28 can be implemented in a mobile computing device. Nonlimiting examples of commercially-available mobile computing devices include laptop computers, tablet computers, vehicle “infotainment” system (i.e. head unit), “smart watches”, and “smartphones”. The mobile computing device may be provisioned with a client software program (also referred to as a “client application” or “client app”) containing appropriate programming for interacting with the method described herein.

In another example, the user interface 28 can be implemented as software accessed through an Internet website (e.g. using an Internet browser program).

User interfaces 28 are able to look up parking locations for any location registered in the system 10, specifically by transmitting a request (1a) to the parking location registry 26, which returns the parking location information (1b). Parking operators may make changes to parking locations from time to time (such as adding or removing new locations, issuing new identifiers, or temporarily closing locations), and these changes are reflected in the system 10 and therefore all connected user interfaces 28 in real time.

Parking locations from any number of parking operators may be registered in the system 10, the locations being stored in the parking location registry 26. When ambiguous parking location identifiers are used, a variety of techniques may be used to determine which zone location a request may be referring to, including the user's location if provided by the user interface 28.

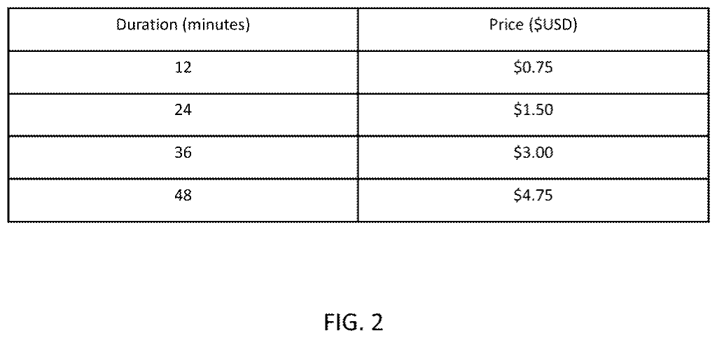

The system 10 provides access to pricing information in a form referred to as “rate increments.” The system 10 provides programmatic access to a series of “rate increments,” calculated by the system 10, specifically the increment generator 24, which describe the cost to park for a given duration based on the vehicle, time of day, local parking policy, local events, parking activity or congestion, and temporary rules/closures. The rate increments may be dependent on formulas or factors as described above. Given a request (2a) from a user interface 28 including a start time, vehicle information, and a parking location the system 10 can provide rate increments (2b) based on the desired parking duration. A visual representation of rate increments is provided in FIG. 2.

Referring to FIG. 2, it will be understood that the values in the column “duration” represents an independent variables or inputs, and the values in the column “price” are dependent variable or outputs. The rate increments are computed by the increment generator 24.

Leveraging rate increments ensures that any Internet-connected user interface 28 can display accurate price information in real time regardless of the parker, user interface 28, local regulations, or device that the application is running on; the complexities of generating the rate increments themselves are performed in the system 10 which allows for very “thin” user interfaces 28 that do not need to be aware of how the calculation was made, and may not have access to information from other clients (such as parking activity/congestion data).

Rate increment calculations based on many complex factors, including both static. e.g., flat cost per hour, or parking duration limits by license plate; or dynamic, e.g., fluctuating price based on nearby parking availability via variables provided at (5) from the transaction database 20. Cities, parking garage operators, and universities may have very diverse rate calculations; however, providing programmatic access to rate increments ensures that connected systems (i.e. user interfaces 28) do not need to be aware of or take additional steps to support this complexity.

User interfaces 28 can complete a transaction by submitting a request (3) to an integrated transaction processing module 22; this module ensures that funds are properly processed and delivered (7) to the parking operator's designed bank account 14, and that support operations (refunds, voids, and other payment-related operations) are available for all transactions regardless of the user interface 28 used to generate the transaction. Stated another way, the user interface 28 does is not required to be programmed to interface with the bank account 14.

When applied to many cities, the parking management system 10 also ensures that funds are routed to the correct bank account 14 at (7) based on the owner of the parking location specified when the transaction was processed. User interfaces 28 do not need to concern themselves with the proper routing of funds.

When a transaction (3) is performed in the transaction processing module 22, data is also generated that can be provided to a variety of internal and external systems, and is routed based on the owner of the parking location. For example, transaction information (4) can be stored in the transaction database 20. In all cases, parking session data is transmitted in real time to enforcement systems at (8) so ensure that parking enforcement officers have access to an up-to-date record of all valid parking sessions; no new integrations or training are required when new user interfaces 28 are added to a parking operator's environment as all parking session data is transmitted through a single flow to the parking enforcement system 16.

In some cases, parking session data may be used in the calculation of rate increments for future transactions; this can enable certain municipal policies that may price based on dynamic signals like parking activity in nearby parking locations (again, summarized for easy consumption by user interfaces 28 via the rate increments).

In some cases, parking session data may be submitted (9) to storage systems 18 maintained by the parking operator 12 or other third parties. The system 10 can provide real-time parking session information from all integrated user interfaces 28 to these storage systems in a consistent format.

The system 10 can support a registry of parking locations from any number of parking operators. These locations are provided to user interfaces 28 via a programmatic interface (1b), but are also used for routing funds, enforcement system integrations, and increment generation when applicable.

By populating the parking location registry 26 with parking locations from multiple operators, user interfaces 28 can leverage the same integration to access parking information and perform parking transactions in any number of locations, regardless of the inputs required to generate the pricing policy (via rate increments), details of how payments are processed, or what additional technologies or services may be active in the environment.

Taken holistically, the system 10 provides a uniform transactional interface that allows for any system, from popular consumer applications, in-dash vehicle systems, commodity hardware devices, autonomous vehicles, and other user interfaces 28 to retrieve parking information and complete parking transactions in any number of parking environments regardless of the policy active in each environment.

Similarly, each parking operator is able to coordinate all user interfaces 28 through the system 10 without regard for the details of each interface (device type, feature set, hardware specifications, etc.).

The parking management system 10 has several advantages over prior art systems. The system reduces the complexity of supporting many different policy an environment configurations; this allows for a much larger group of user interfaces to provide parking payment functionality than is currently possible in existing solutions.

The parking management system 10 provides a method for decoupling environmental details from the user interface 28. As a result, a variety of user interfaces become available that are not possible to support in the prior art.

Leveraging rate increments ensures that any Internet-connected user interface 28 can display accurate price information in real time regardless of the parker or user interface.

The parking management system 10 does not require specialized knowledge or technical effort to support additional parking operators (cities, universities, parking garage operators), regardless of the local policy that drives the pricing or availability of parking spaces. Any number of internet-connected applications, software applications, and devices may utilize the invention to generate parking transactions with no incremental complexity.

Similarly, the parking management system 10 also allows parking operators to manage policies, generate reports, and configure funds flow through a single system regardless of how many end user interfaces may be active in their environment.

With the parking management system 10, providers of user interfaces are not required to make any operator-specific configurations when the system is in use.

The foregoing has described a system for parking management. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A parking management system, comprising:
a rate increment generator operable to:
compute one or more rate increments based on at least one of: a vehicle identification, a time of day, a local parking policy, a local events, a parking congestion, and a temporary rule;
store the at least one rate increment; and
transmit the at least one rate increment in response to an inquiry from a user interface.

2. The parking management system of claim 1 further comprising a transaction database operable to store records of parking transactions.

3. The parking management system of claim 1 further comprising a transaction processing module operable to interact with at least one financial account.

4. The parking management system of claim 1 further comprising a parking location registry operable to store information about parking locations.

5. The parking management system of claim 1 wherein the rate increment generator comprises software in a computer server.

6. The parking management system of claim 1 wherein the rate increment generator comprises software accessed through an Internet website using an Internet browser program.

7. The parking management system of claim 1 in combination with at least one user interface in data communication with the parking management system.

8. The combination of claim 7 wherein the user interface comprises at least one of firmware and software in a parking meter.

9. The combination of claim 7 wherein the user interface comprises software in a mobile computing device.

10. The combination of claim 7 wherein the user interface comprises software accessed through an Internet website using an Internet browser program.

11. A method for parking management, comprising:
transmitting a request from a user interface to a parking management system, the request including a start time, a duration, vehicle information, and a parking location;
using the parking management system, computing a rate increment based on the request and on at least one of: a vehicle identification, a time of day, a local parking policy, a local events, a parking congestion, and a temporary rule; and
transmitting the rate increment to the user interface.

12. The method of claim 11 further comprising storing records of parking transactions in a transaction database.

13. The method of claim 11 further comprising:
receiving a transaction request from the user interface; and
using a transaction processing module, interacting with at least one financial account to process the transaction request.

14. The method of claim 11 further comprising storing information regarding parking locations in a parking location registry.

15. The method of claim 11 wherein the parking management system comprises software in a computer server.

16. The method of claim 11 wherein the parking management system comprises software accessed through an Internet website using an Internet browser program.

17. The method of claim 11 wherein the user interface comprises at least one of firmware and software in a parking meter.

18. The method of claim 11 wherein the user interface comprises software in a mobile computing device.

19. The method of claim 11 wherein the user interface comprises software accessed through an Internet website using an Internet browser program.
